(19) United States
(12) Patent Application Publication
(10) Pub. No.: US 2008/0286998 A1
(43) Pub. Date: Nov. 20, 2008

(54) Pluggable module suppressing EMI / ESD leakage

(75) Inventors: Shigeichi Izumi, Yokohama (JP); Hiroshi Nishimoto, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/153,374

(22) Filed: May 16, 2008

(30) Foreign Application Priority Data
May 18, 2007 (JP) 2007-133502

(51) Int. Cl. H01R 13/53

(52) U.S. Cl. 439/181

(57) ABSTRACT

A connecting apparatus includes equipment having a cabinet with an opening and a connector inside the cabinet. A module has an electrical circuit and a resilient conductor and is attachable to the cabinet through the opening and thereby pluggable to the equipment. When the module is plugged to the equipment, the electrical circuit of the module is connected to the connector of the equipment, the resilient conductor fills a gap in the opening between the module and the cabinet and the module and the cabinet is electrically connected, and static electricity charged on the module propagates through the resilient conductor to the cabinet.

The present application is related to and claims the benefit of foreign priority to Japanese application 2007-133502, filed on May 18, 2007 in the Japan Patent Office, which is incorporated herein by reference in its entirety.

### BACKGROUND

### Description of the Related Art

For a module connecting an optical fiber to an optical communication apparatus, a pluggable module that can be mounted or replaced from a front side of the optical apparatus has widely been used. With an increasing speed of optical communication in recent years, it is demanded to enhance suppression of ESD (Electrostatic Discharge)/EMI (Electro Magnetic Interference) of pluggable modules as well as optical communication apparatus bodies.

To obtain better suppression of ESD/EMI of pluggable module, a configuration having a member causing static electricity in the module to propagate to a cage for protecting the module is known, such as one disclosed in Japanese Patent Application Laid-Open No. 2006-113455.

FIG. 11 is a diagram showing a pluggable module according to a related art. As shown in FIG. 11, a pluggable module 10 is a module to be connected to an optical connector 50 containing an optical fiber 501. The pluggable module 10 is inserted into an apparatus 8 through an insertion opening provided in a cabinet 30 of the apparatus 8 before being electrically connected to a circuit board 40 inside the apparatus 8 via a connector 401.

A cage 20 is mounted on the circuit board 40 to protect the pluggable module 10. A spring 201 is provided inside the cage 20 to cause static electricity charged to the outside portion of pluggable module 10 to propagate to the cage 20. A metallic member 202 is fixed to the cage 20 and the cabinet 30 by spot welding 202a and the static electricity propagated to the cage 20 is conducted to the cabinet 30 acting as a ground through the metallic member 202.

### SUMMARY

A connecting apparatus includes: equipment having a cabinet with an opening and a connector inside the cabinet. A module which is attachable to the cabinet through the opening and thereby pluggable to the equipment, has an electrical circuit and a resilient conductor. When the module is plugged to the equipment, the electrical circuit of the module is connected to the connector of the equipment, the resilient conductor fills a gap in the opening between the module and the cabinet, and the module and the cabinet are electrically connected. Static electricity charged on the module propagates through the resilient conductor to the cabinet.

The subject matter which is regarded as the invention is particularly pointed out and distinctly claimed in the concluding portion of the specification. The invention, however, together with further objects and advantages thereof, may best be understood by reference to the following description taken in conjunction with the accompanying drawings.

### BRIEF DESCRIPTION OF THE DRAWINGS

FIG. 1 is a diagram showing a pluggable module according to an embodiment;

FIG. 2 is a perspective view of the pluggable module according to an embodiment;

FIG. 3 is a diagram showing a pluggable module according to an embodiment;

FIG. 4 is a diagram showing a pluggable module according to an embodiment;

FIG. 5 is a diagram showing a pluggable module according to an embodiment;

FIG. 6 is a diagram showing a pluggable module according to an embodiment;

FIG. 7 is a diagram showing a pluggable module according to an embodiment;

FIG. 8 is a diagram showing a pluggable module according to an embodiment;

FIG. 9 is a diagram showing a pluggable module according to an embodiment;

FIG. 10 is a diagram showing a pluggable module according to an embodiment; and

FIG. 11 is a diagram showing a pluggable module according to a related art.

### DETAILED DESCRIPTION OF THE PREFERRED EMBODIMENT

Reference will now be made in detail to embodiments of the present invention, examples of which are illustrated in the accompanying drawings, wherein like reference numerals refer to like elements throughout.

First, a relationship between decreasing a size of a module and the corresponding ESD issue is described. By decreasing a size of a module, a distance between a cabinet of the module and a circuit board inside the module is shortened.

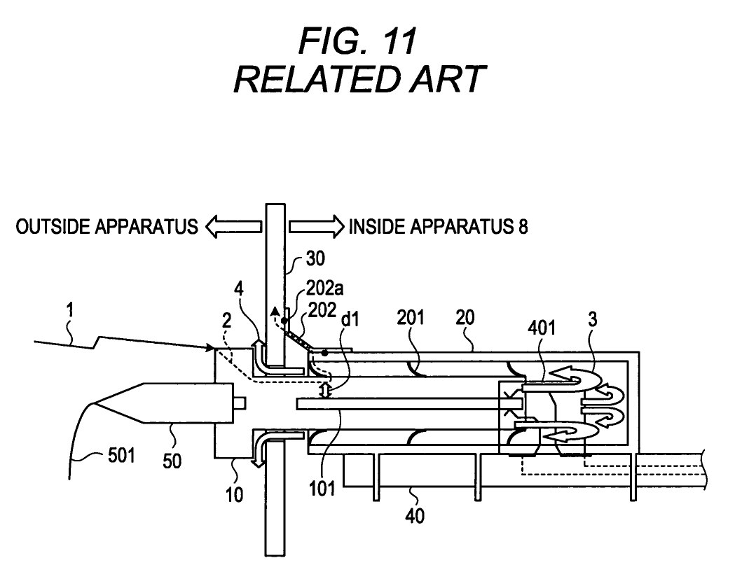

Accordingly, in the related art shown in FIG. 11, for example, even if a structure to allow static electricity charged to the outside portion of the module to escape to a cage is present, there are cases where static electricity discharges to a circuit board and causes malfunctioning, circuit component breakdown and the like.

Also, a gap present between an insertion opening for inserting a module into an apparatus and the module can act as a path for EMI. Such gap is due to a dimensional tolerance or the like.

Referring to FIG. 11, it is preferable that static electricity 1 is conducted from outside the apparatus 8 to the cabinet 30 by passing through a discharge route 2, from the pluggable module 10, through the spring 201, the cage 20, and the metallic member 202, to the cabinet 30.

However, since a distance d1 between the spring 201 and a circuit board 101, which controls optical elements inside the pluggable module 10, is short, there are cases where static electricity discharges to the circuit board 101 and causes a malfunction, circuit component breakdown and the like. This problem becomes more serious with further decrease in the size of the pluggable module 10 due to communication speedups or composition with higher densities.

Also in FIG. 11, since there arises a gap between the insertion opening provided in the cabinet 30 and the pluggable module 10 due to a dimensional tolerance or the like, there is another problem that EMI 3 emitted from the pluggable module 10 or the connector 401 or EMI (not shown) generated inside the apparatus, leaks out as EMI 4.

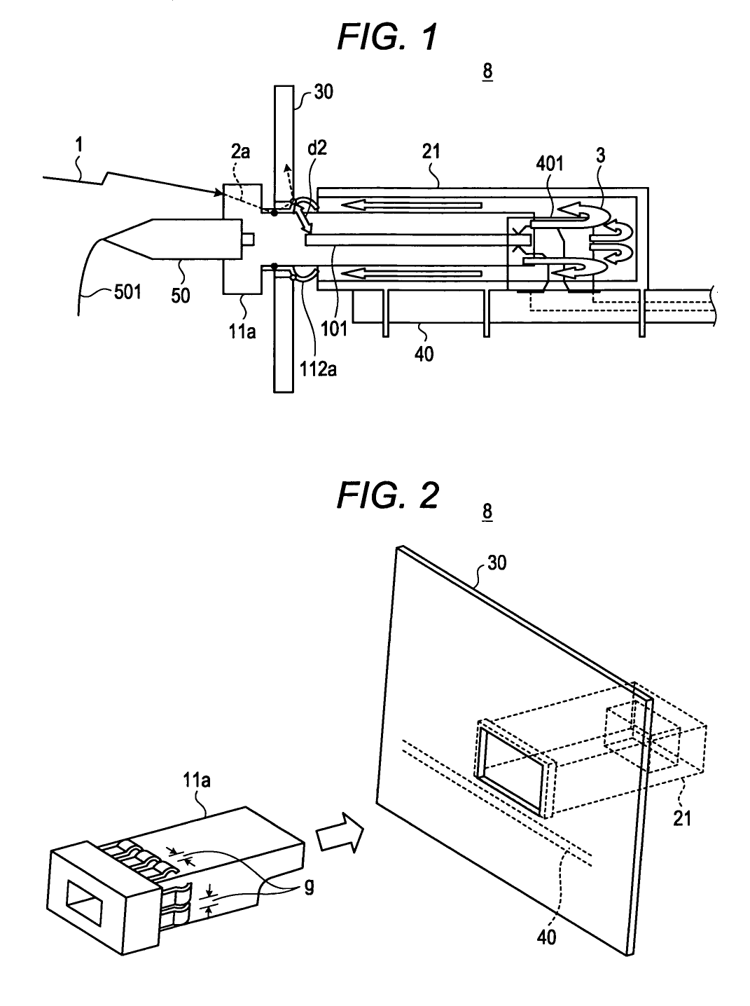

FIG. 1 is a diagram showing a pluggable module 11a according to an embodiment. As shown in FIG. 1, the pluggable module 11a includes a shield spring 112a. The shield spring 112a fills a gap between an insertion opening provided in the cabinet 30 and the pluggable module 11a. The pluggable module 11a comes into contact with the cabinet 30 by the shield spring 112a due to elastic force, after being inserted into an apparatus 8. The shield spring 112a can be a resilient conductor that can isolate the module outside the cabinet and the inside the cabinet, made of a conductive material, for example, metal, metalized resin, or the like.

Static electricity 1 conducted to the pluggable module 11a from outside the apparatus 8, propagates through the discharge route 2a from the pluggable module 11a to the shield spring 112a and the cabinet 30. Thus, it is not necessary to provide a spring 201 for the cage 21 or the metallic member 202 in order to protect the pluggable module 11a.

In this configuration, since the shield spring 112a in the pluggable module 11a is directly in contact with the cabinet 30 of the apparatus 8, the static electricity reaches the cabinet 30 through the discharge route 2a without coming close to the circuit board 101. This makes it easier to protect the circuit board 101 inside the pluggable module 11a.

Also in this configuration, as the gap between the insertion opening provided in the cabinet 30 and the pluggable module 11a is filled by the shield spring 112a, it is possible to inhibit leakage of the EMI 3 or the like emitted from the pluggable module 11a or the connector 401 through the gap.

FIG. 2 is a perspective view of the pluggable module 11a. As shown in FIG. 2, the pluggable module 11a includes a plurality of shield springs 112a on a top surface, both sides, and an undersurface thereof. In order to inhibit leakage of EMI, a gap g between each of the shield springs 112a is preferably not higher than ⅕ of a wavelength X of EMI.

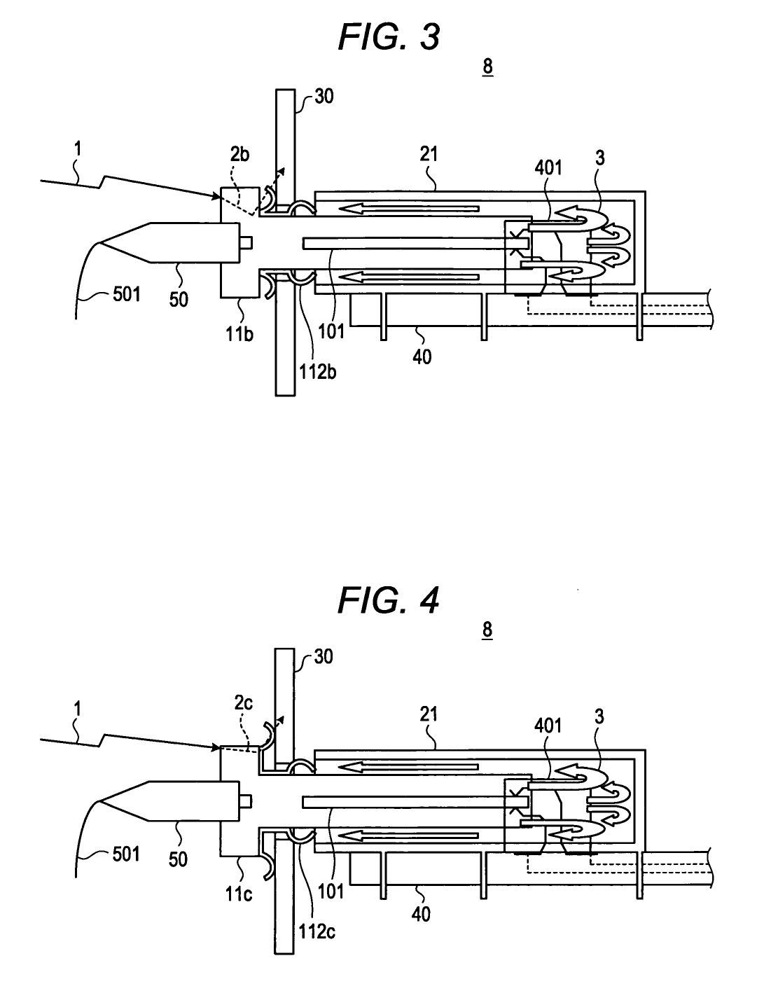

Referring to FIG. 3, a pluggable module 11b has a structure in which a shield spring 112b is in contact with the cabinet 30 not only inside the apparatus 8, but also outside the apparatus 8. By this configuration, a discharge route 2b is remote from the circuit board 101, and the circuit board 101 is less likely to be affected by static electricity.

Referring to FIG. 4, a pluggable module 11c has a structure in which a portion where a shield spring 112c is in contact with the cabinet 30 outside the apparatus is apart from the center of the pluggable module 11a. Therefore, a discharge route 2c is made further remote from the circuit board 101 and the circuit board 101 is less likely to be affected by static electricity.

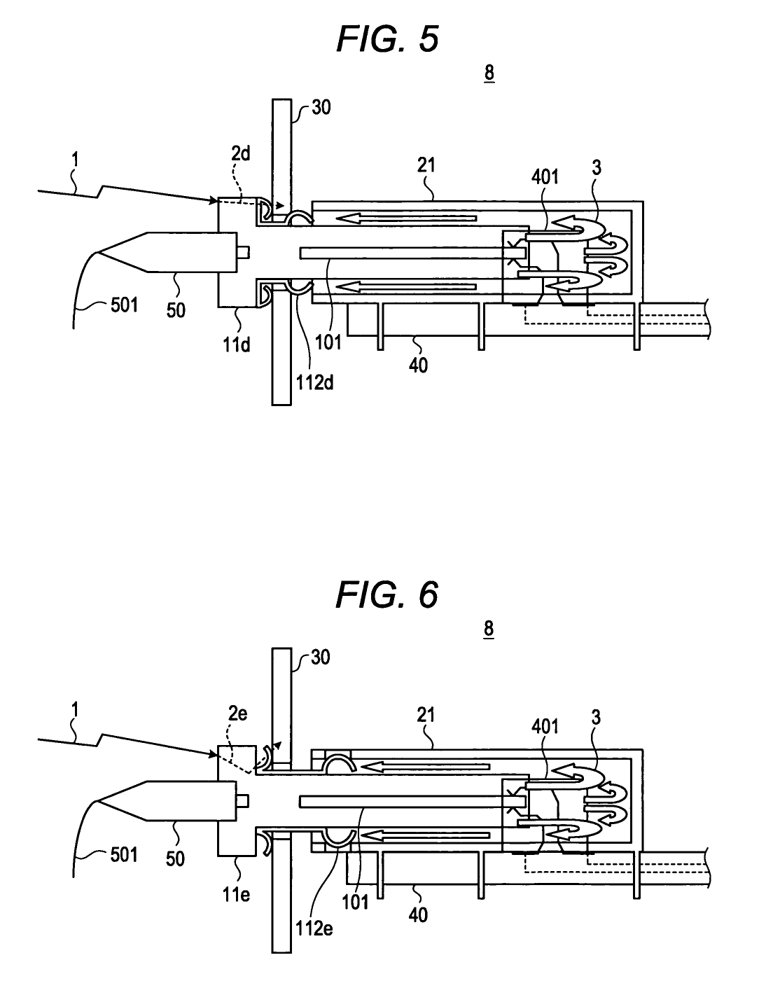

Referring to FIG. 5, a pluggable module lid has two bending portions of the shield spring 112d extending in the same direction, different from the pluggable module 11b shown in FIG. 3 and the pluggable module 11c shown in FIG. 4. That is, a bending portion that brings the shield spring 112d into contact with the cabinet 30 outside the apparatus 8 and a bending portion that is exposed to the outside of the apparatus 8 extends the same direction. Therefore, while having an effect similar to that of the pluggable module 11b shown in FIG. 3 or the pluggable module 11c shown in FIG. 4, the pluggable module lid in FIG. 5 has a structure that is easier to work on than that of these pluggable modules.

Referring to FIG. 6, a pluggable module 11e has a structure in which a shield spring 112e is in contact with the cabinet 30 outside the apparatus with a structure similar to the shield spring 112b of the pluggable module 112b in FIG. 3. Additionally, the shield spring 112e is not in contact with the cabinet 30 inside the apparatus, but is in contact with the cage 21. Accordingly, the pluggable module 11e has a structure that inhibits leakage of EMI from inside the cage.

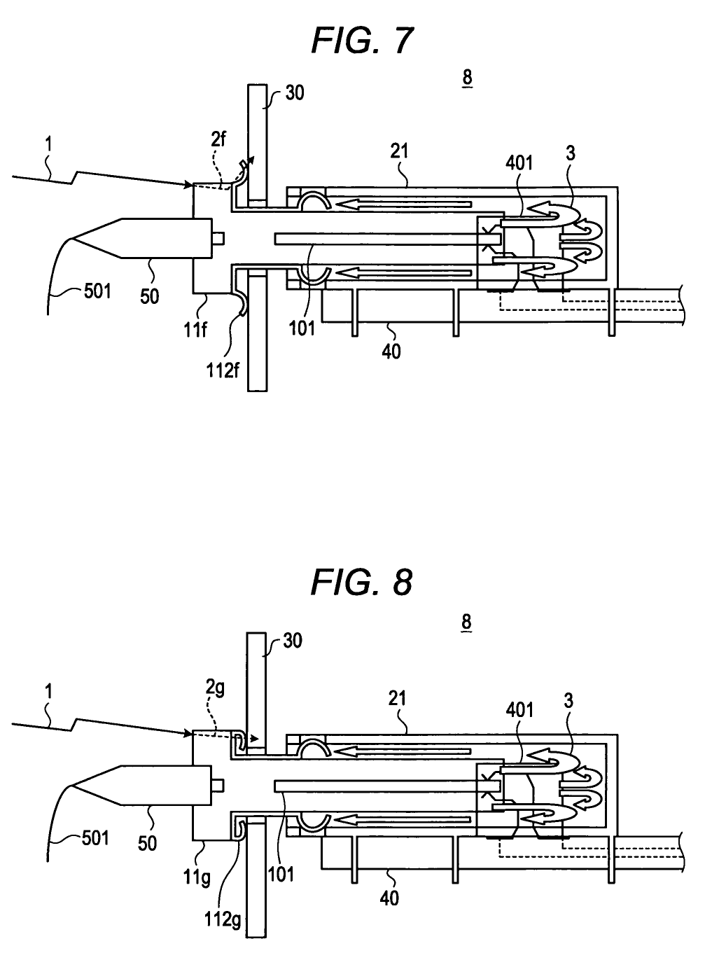

Referring to FIG. 7, a pluggable module 11f has a structure in which a shield spring 112f is in contact with the cabinet 30 outside the apparatus with a structure similar to the shield spring 112c of the pluggable module 112c in FIG. 4. Additionally, the shield spring 112f is not in contact with the cabinet 30 inside the apparatus, but is in contact with the cage 21. Accordingly, the pluggable module 11f has a structure that inhibits leakage of EMI from inside the cage.

Referring to FIG. 8, a pluggable module 11g has a structure in which a shield spring 112g is in contact with the cabinet 30 outside the apparatus with a structure similar to the shield spring 112d of the pluggable module 112d in FIG. 5. Additionally, the shield spring 112g is not in contact with the cabinet 30 inside the apparatus, but is in contact with the cage 21. Accordingly, the pluggable module 11g has a structure that inhibits leakage of EMI from inside the cage.

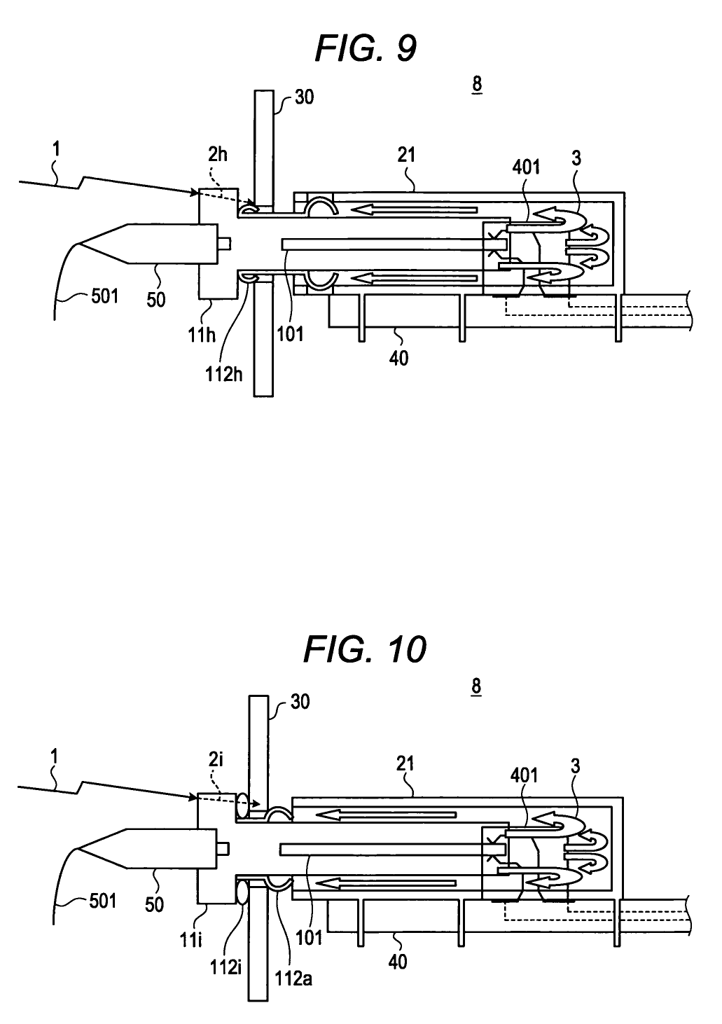

Referring to FIG. 9, a pluggable module 11h has a structure in which a shield spring 112h is in contact with the cabinet 30 outside the apparatus. Additionally, the shield spring 112h is not in contact with the cabinet 30 inside the apparatus, but is in contact with the cage 21. Thus, the pluggable module 11h has a structure that inhibits leakage of EMI from inside the cage.

As described above, in the embodiments shown in FIGS. 1 to 9, a shield spring is provided near a gap between a pluggable module and a cabinet of an apparatus to allow static electricity charged to the outside portion of the pluggable module to escape to the cabinet of the apparatus and also to fill the gap between the pluggable module and the cabinet of the apparatus by the shield spring. Therefore, suppression of ESD/EMI of the pluggable module is increased.

In the above embodiments, examples of suppressing ESD/EMI of a pluggable module by using a shield spring are shown, but suppression of ESD/EMI can also be enhanced by using members other than the shield spring.

Referring to FIG. 10, in a pluggable module 11i a conductive resin is used in combination to enhance suppression of ESD/EMI of the pluggable module 11i.

As shown in FIG. 10, the pluggable module 11i includes a conductive resin 112i in addition to the shield spring 112a shown in FIG. 1. When the pluggable module 11i is inserted into the insertion opening of the cabinet 30, the conductive resin 112i comes into contact with the cabinet 30 and also a space between the pluggable module 11i and the cabinet 30 is filled. The conductive resin 112i is, for example, a rubber with metallic filler or conductive fiber around a circumference thereof and preferably has elasticity.

Since the conductive resin 112i provided by the pluggable module 11i is directly in contact with the cabinet 30 of the apparatus in this configuration, static electricity reaches the cabinet 30 without coming close to the circuit board 101 on the discharge route 2i. This makes protection of the circuit board 101 inside the pluggable module 11i easier.

Also in this configuration, the space between the cabinet 30 and the pluggable module 11i is filled by the conductive resin 112i. Therefore, the EMI 3 and the like emitted from the pluggable module 11i and the connector 401 can be inhibited from leaking out through the gap between the cabinet 30 and the pluggable module 11i. By using a conductive resin in combination, as described above, better suppression of ESD/EMI of the pluggable module.

As described above, a conductive member is provided in a pluggable module to allow static electricity charged to the outside portion of the pluggable module to escape to a cabinet of an apparatus by way of the conductive member and also to fill a gap between the pluggable module and the cabinet of the apparatus to inhibit leakage of EMI. Therefore, better suppression of ESD/EMI of the pluggable module is provided with a simple structure.

Although a few preferred embodiments of the present invention have been shown and described, it would be appreciated by those skilled in the art that changes may be made in these embodiments without departing from the principles and spirit of the invention, the scope of which is defined in the claim and their equivalents.

What is claimed is:

1. A connecting apparatus, comprising:
equipment having a cabinet with an opening and a connector inside the cabinet; and
a module attachable to the cabinet through the opening and thereby pluggable to the equipment, having an electrical circuit and a resilient conductor; wherein,
when the module is plugged to the equipment,
the electrical circuit of the module is connected to the connector of the equipment,
the resilient conductor fills a gap in the opening between the module and the cabinet, and the module and the cabinet are electrically connected.).

2. The connecting apparatus according to claim 1, wherein static electricity charged on an outside portion of the module propagates through the resilient conductor to the cabinet.

3. The connecting apparatus according to claim 1, wherein the resilient conductor isolates the module outside the cabinet and the module inside the cabinet electrically.

4. The connecting apparatus according to claim 1, wherein the resilient conductor fills the gap in the opening from inside the equipment when the module is plugged to the equipment.

5. The connecting apparatus according to claim 1, wherein the resilient conductor fills the gap in the opening from outside the equipment when the module is plugged to the equipment.

6. The connecting apparatus according to claim 1, wherein the resilient conductor fills the gap in the opening both from inside the equipment and from outside the equipment when the module is plugged to the equipment.

7. The connecting apparatus according to claim 1, wherein the resilient conductor is a spring.

8. The connecting apparatus according to claim 1, wherein the resilient conductor is made of metal.

9. The connecting apparatus according to claim 1, wherein the resilient conductor is made of metalized resin.

10. A module pluggable to equipment having a cabinet with an opening and a connector inside the cabinet, comprising:
an electrical circuit connected to the connector of the equipment when the module is plugged to the equipment; and
a resilient conductor filling a gap in the opening between the module and the cabinet when the module is plugged to the equipment to electrically connect the module and the cabinet.

11. The module according to claim 10, wherein static electricity charged on an outside portion of the module propagates through the resilient conductor to the cabinet when the module is plugged to the equipment.

12. The module according to claim 10, wherein the resilient conductor isolates the module outside the cabinet and the module inside the cabinet electrically.

13. The module according to claim 10, wherein the resilient conductor fills the gap in the opening from inside the equipment when the module is plugged to the equipment.

14. The module according to claim 10, wherein the resilient conductor fills the gap in the opening from outside the equipment when the module is plugged to the equipment.

15. The module according to claim 10, wherein the resilient conductor fills the gap in the opening both from inside the equipment and from outside the equipment when the module is plugged to the equipment.

16. The module according to claim 10, wherein the resilient conductor is a spring.

17. The module according to claim 10, wherein the resilient conductor is made of metal.

18. The module according to claim 10, wherein the resilient conductor is made of metalized resin.
